(19) United States
(12) Patent Application Publication
(10) Pub. No.: US 2010/0098623 A1
(43) Pub. Date: Apr. 22, 2010

(54) ZEOLITE MATERIALS AND SYNTHESIS METHOD THEREOF

(76) Inventors: Bogdan Gagea, Leuven (BE); Pierre Jacobs, Gooik (BE); Johan Martens, Huldenberg (BE); Hans Vandepitte, Aarschot (BE)

Correspondence Address: BACON & THOMAS, PLLC, 625 SLATERS LANE, FOURTH FLOOR, ALEXANDRIA, VA, 22314-1176, US

(21) Appl. No.: 12/526,414

(22) PCT Filed: Feb. 7, 2008
(86) PCT No.: PCT/BE08/00006

§ 371 Date: Aug. 7, 2009

(30) Foreign Application Priority Data
Feb. 7, 2007 (GB) 0702327.8

(51) Int. Cl. C01B 39/04; C01B 39/40

(52) U.S. Cl. 423/704; 423/702; 423/700

(57) ABSTRACT

The present invention provides zeolites and zeolite-like material having an enhanced microporosity. It was found that such zeolites can be obtained using a zeolite synthesis method comprising the preparation of a gel or solution for the synthesis of a zeolite, said gel or solution comprising appropriate amounts of (i) a conventional monomeric or polymeric silica source and (ii) a molecular template as a microstructuring agent, characterized in that said gel or solution further comprises an organosilane compound having limited self-assembling capacity.

### FIELD OF THE INVENTION

The present invention relates to a method allowing the production of zeolites with enhanced microporosity as well as to zeolites having an enhanced microporosity.

### BACKGROUND OF THE INVENTION

Synthetic zeolites represent an important family of technical materials that find application in catalytic decomposition or rearrangement of organic molecules, catalytic decomposition of toxic gases, selective adsorption of certain gaseous components, ion-exchange, molecular separations, sensor devices, controlled release, non-linear optics among others.

According to the International Zeolite Association, zeolites are crystalline materials with a framework density (FD, i.e. the number of tetrahedrally coordinated atoms per 1000 Å³) below 21 depending on the size of the smallest ring. [Ref. 1] The general chemical formula based on a 4-connected network of a zeolite is as follows:

MₓM′_{y}N_{z}[TₘT′_{n′}.O_{2(m+n+ . . . )-ε}(OH)_{2ε}](OH)_{br}(aq)ₚ.qQ (1)

where T atoms can be Si, Al, Be, B, Ga, Ge, P or even secondary group elements such as Zn. M & M′ are exchangeable and non-exchangeable metal cations, N non-metallic cations (generally removable on heating), (aq) chemically bonded water (or other strongly held ligands of T-atoms), and Q sorbate molecules which need not be water. The essential part in square brackets denotes the 4-connected framework which is usually anionic. [Ref. 2]

Chemically, zeolites are mixed oxides. The main framework elements are silicon or phosphorous. Secondary framework elements are aluminium, titanium, gallium, boron, iron, cobalt among others. The chemical composition of a zeolite can be rationalized using the concept of isomorphic substitution. [Ref. 3]

Zeolite synthesis is currently performed using the hydrothermal gel method. The first generations of zeolites including zeolite A, zeolite X, zeolite Y are crystallized from an inorganic hydrogel obtained by mixing a source of silica, a source of alumina with alkaline- or alkaline earth-metal hydroxide and water. These zeolites are characterized by high aluminum content. For the synthesis of high-silica zeolites, typically organic molecules coined as molecular templates are added to the hydrogel. The molecular templates during synthesis are incorporated in the pores of the zeolite crystals and can be removed through leaching, ion-exchange or calcination. Examples of high-silica zeolites among many others are ZSM-5 [Ref. 4] and Silicalite-1 [Ref. 5,6] The framework connectivity of a zeolite is denoted with a three letter code. [Ref. 7] For example, “MFI” refers to a specific framework topology encountered in the zeolites ZSM-5, TS-1 and Silicalite-1.

The particle size of technical zeolite crystals typically is of the order of 1 μm. For many applications there is interest in alternative structuring of zeolite matter. [Ref. 8] Especially the shortening of the length of the zeolite channels is searched for. By altering the synthesis procedures the particle size can be decreased to the nanometer range. [Ref. 9] Another way to limit the zeolite particle size is by creating hierarchical materials presenting ordering at two or, more length scales comprising the nano and meso or macro scale. [Ref. 10] Examples of hierachical materials are the so called zeotiles [Ref. 11] and zeogrid [Ref. 12] and the materials prepared with zeolite precursor units [Ref. 13-16] and mesoporous zeolites. [Ref. 17, 18] Ordering at the mesoscale can be achieved by using supramolecular templates such as surfactant molecules or polymers. The supramolecular template generating mesopores can be provided as an amphiphilic organosilane surfactant molecule such as [3-trimethoxysilyl)propyl]hexadecyldimethylammonium chloride. [Ref. 19]

WO2007043731 discloses a method for the production of microporous zeolites comprising mesopores for improving the ability of molecules to diffuse towards the active sites of the catalyst. The creation of these mesopores is achieved by using so called mesopore forming agents in the synthesis of such zeolites. In a particular embodiment said mesopore forming agents are organosilanes carrying an organic functional group, wherein the non-covalent interactions between said organic functional groups defines the mesopores, which are then framed by the covalent bonds of Si—O—R. WO2007043731 further teaches that if nature of said organic group is such that it does not allow stable non-convalent interactions between these organic groups, the formation of mesopores is promoted by adding a surfactant to stabilize the formed mesopore frame structure.

U.S. Pat. No. 5,194,410 describes organosilane molecules comprising a quaternary ammonium for use as a microstructure directing molecular template.

The present invention is based on the finding that the use of organosilane reagents, comprising silicon directly linked to the carbon atom of an organic moiety of limited molecular size leads to the synthesis of mates with enhanced microporosity, without substantially modifying the mesoporosity of the zeolite. The method is used in the synthesis a zeolite in combination with a molecular template, added as a separate molecule. The possibility of enhancing the microporosity of zeolites has the important advantage that it increases the accessibility of the micropores for larger molecular structure.

### SUMMARY OF THE INVENTION

The present invention provides zeolites and zeolite-like material having an enhanced microporosity. It was found that such zeolites can be obtained using a zeolite synthesis method comprising the preparation of a gel or solution for the synthesis of a zeolite, said gel or solution comprising appropriate amounts of (i) a conventional monomeric or polymeric silica source and (ii) a molecular template as microstructuring agent, characterized in that said gel or solution further comprises an organosilane compound having limited self-assembling capacity.

### DETAILED DESCRIPTION OF THE INVENTION

### Legends to the Figures

FIG. 1 N₂ physisorption isotherms of zeolite materials from Example 1 and Comparative Example 7.

FIG. 2 XRD patterns of the zeolites from Examples 1 and 2 and Comparative Example 7.

FIG. 3 FT-IR patterns of the zeolites from Examples 1 and 2 and Comparative Example 7.

FIG. 4A. Decane conversion vs. Temperature

FIG. 4B. Yield of skeletal isomers from decane vs. decane conversion.

FIG. 5 The mesopore size distribution (range of pore diameters 2-50 nm) of the zeolites synthesized in Example 1 and example 7.

### DESCRIPTION

In the context of the present invention the term ‘zeolite’ refers to a crystalline microporous material comprising coordination polyhedra formed only of silicon, aluminum and oxygen. Non-aluminosilicate analogs of microporous crystals such as pure silicates, titanosilicates, silicoaluminophosphates and borosilicates, ferrosilicates, germanosilicates and gallosilicates, that exhibit the characteristic molecular-sieving properties similarly to zeolites, are referred to as zeolite-like' materials. In the present invention both zeolites and zeolite-like materials are encompassed by the term ‘zeolite’. A publication entitled “Atlas of Zeolite Structure Types”, 5th Revised Edition (2001) by authors W. M. Meier, D. H. Olson and Ch. Baerlocher, is a good source of the known zeolites and zeolite-like materials. More particularly the term “zeolite” refers to zeolites and zeolite-like material having a zeolite framework of the type AEI, AEL, AFI, AFO, AFR, AFX, ATN, ATO, BEA, CDO, CFI, CHA, CON, DDR, DON, EMT, EON, EUO, FAU, FER, IFR, IHW, ISV, ITE, ITH, ITW, IWR, IWV, IWW, LEV, LTA, LTL, MAZ, MEI, MEL, MER, MFI, MFS, MOR, MOZ, MSE, MSO, MTF, MTN, MTT, MTW, MWW, NON, RRO, RTE, RTH, RWR, SFE, SFF, SFG, SFH, SFN, SGT, SSY, STF, STT, TON or TUN (hftp://izasc.ethz.ch/fmi/xsl/IZA-SC/ft.xsl). Proven recipes and good laboratory practice for the synthesis of zeolites can be found in the “Verified synthesis of zeolitic materials” 2^{nd} Edition 2001. [Ref. 20] Convenient silica sources are sodium silicate, colloidal silica sol, fumed silica, precipitated silica and silicon alkoxides. [Ref. 21] Next to the conventional hydrothermal conditions for synthesis of zeolites from hydrogel under basic conditions, the synthesis of these zeolites can be performed under several types of alternative conditions such as in acid medium in presence of fluoride medium [Ref. 22], or in a “clear solution”. [Ref. 23] In a synthesis based on the “clear solution” concept a silicon alkoxide is hydrolyzed in presence of a high concentration of organic molecular template such that the starting mixture is a solution rather than a gel.

In the context of the prior art and the present invention following compounds can be used as ‘molecular templates’, tetraalkyl ammonium compounds, for instance tetramethylammonium, tetraethylammonium and tetrapropylammonium, amines, alcohols, amino alcohols, crown ethers among others.

In the context of the prior art and the present invention, “micropores” refers to pores within the zeolite crystals having diameters of 0.3 nm to 2 nm and “mesoporous” refers to pores in the zeolite crystal having diameters of 2 nm to 50 nm. For pore shapes deviating from the cylinder, the above ranges of diameter of micropores and mesopores refer to equivalent cylindrical pores.

In the context of the present invention “enhanced microporosity” refers to an increased micropore volume due to a relatively larger pore size of the pores within the microporous range. More particularly, the term “enhanced porosity” refers to the relatively higher micropore volume of the zeolites of the present invention as compared to corresponding zeolites produced using a conventional method.

In the context of the present invention the term “self-assembling capacity” of an organic compound refers to the capacity of such compounds to align by noncovalent bonds such as van der Weals force, dipole-dipole moment and ionic interaction. In the context of the present invention it is preferred to use organosilane compounds comprising an organic group having low self-assembling capacity, which refers to the fact that the nature of these organic group does not allow the organosilanes to form supramolecular structures within the size range of the mesopores (2 to 50 nm).

The term “aromatic group” refers both to an aryl or heteroaryl. The term “aryl” as used herein means an aromatic hydrocarbon radical of 6-20 carbon atoms derived by the removal of hydrogen from a carbon atom of a parent aromatic ring system. Typical aryl groups include, but are not limited to 1 ring, or 2 or 3 rings fused together, radicals derived from benzene, naphthalene, anthracene, biphenyl, and the like. The term “heteroaryl” as used herein means an aromatic ring system including at least one N, O, S, or P.

The present invention aims at providing zeolites having an enhanced microporosity. It was found that such zeolites can be obtained when part of the silica source in the gel or solution for the synthesis of the zeolite is substituted with an organosilane compound having an organic group, which has insufficient self-assembling capacity to generate supramolecular templates defining mesopores in the final zeolitic material. Preferably, said organosilanes are used in combination with a molecular template. Therefore, in a first object the present invention provides a method for the synthesis of a microporous zeolite, said method comprising the preparation of a gel or solution for the synthesis of a zeolite, said gel or solution comprising appropriate amounts of (i) a conventional monomeric or polymeric silica source and (ii) a molecular template, characterized in that said gel or solution further comprises an organosilane compound having limited self-assembling capacity.

In a preferred embodiment of the method of the present invention said organosilane is a compound according to the general formula Si(OR₁)ₓ(R₂)_{y}(R₃)_{z}(R₄)_{w} in which x can be 1, 2 or 3; y, z and w can be 0, 1, 2, or 3 and x+y+z+w=4. R₁ is an alkyl group selected from methyl, ethyl, propyl or a longer aliphatic chain;
each R₂, R₃ and R₄ are independently selected from a C₁₋₃ alkyl, C₁₋₃ alkenyl or an aromatic group wherein said alkyl, alkenyl or aromatic group may be unsubstituted or may have at least one substituent selected out of the group consisting of amino, nitro, cyano, amide ammonium, alcohol, halide, alkene, phenyl, thiol carboxylic acid, sulphonic acid, haloalkyl, glycidyl, aryl or heteroaryl; R₂, R₃, R₄ can be identical groups or can be different, however, nor R₂, R₃ or R₄ comprises an quaternary ammonium.

In another preferred embodiment of the present invention the organosilane molecule has the general formula (R₁O)₃Si—R—Si(OR₁)₃, where R₁ is an alkyl group selected from methyl, ethyl, propyl or a longer aliphatic chain and R is an aliphatic or aromatic organic group containing from 1 to 20 C atoms and wherein said aromatic group may have at least one substituent selected out of the group consisting of amino, nitro, cyano, amide ammonium, alcohol, halide, alkene, phenyl, thiol carboxylic acid, sulphonic acid, glycidyl, aryl or heteroaryl.

In a particular embodiment the organosilane compound is selected out of the following compounds: phenyl-trimethoxysilane, amino-phenyl-trimethoxysilane (o- and p-isomers), bromo or chloro-phenyl-trimethoxysilane, and p-chloromethyl-phenyl-trimethoxysilane, 3-(aminopropyl)trimethoxysilane or 3-(chloropropyl)trimethoxysilane, benzyl-triethoxysilane, bis-triethoxysilyl-nonane, bis-triethoxysilyl octane, bis-triethoxysilyl hexane, bis-triethoxysilyl ethane, 1,4-bis-trimethoxysilyl-ethyl-benzene and bis-trimethoxysilyl-propyl-amine.

In another particular embodiment the organosilane molecules for use in a method according the present invention are not 3-(aminopropyl)trimethoxysilane or 3-(chloropropyl)trimethoxysilane.

In a more preferred embodiment, the fraction of silicon atoms introduced as organosilanes into the synthesis mixture for making the zeolite is in the range from 0.01 to 0.50, more preferably in the range from 0.1 to 0.5. In a particular aspect of the present invention the enhancement of the pore volume can be controlled by the fraction of organosilanes introduced in the synthesis mixture.

Optionally, a source of another element is added to the synthesis mixture for synthesizing a zeolite with any composition as described in the general zeolite formula (Eqn. 1). An example is titanium that can be added conveniently as a titanium alkoxide, e.g. tetrabutyl ortho-titanate. Aluminum can be added as aluminum salt, aluminum alkoxide, aluminum metal, aluminum hydroxide the invention not being limited to these ad elements such as B, Ga, Ge and Fe, P can be introduced as well.

It is preferred that the said gel or solution for the synthesis of the zeolite comprises no or only limited amounts, for instance less than 1 mol % based on the amount of SiO₂ or its precursor, of an additive capable of noncovalently bonding with each other and the organosilanes of the present invention. The presence of such additives may lead to the incorporation of the organosilanes in large supramolecular structures leading to the formation of mesopores in the eventual zeolite instead of the formation of an enhanced microporosity. Examples of such less desired additives having self-assembling capacity are organic molecules, such as alcohols typically comprising more than 5 C atoms, for instance more than 10; surfactants, such as anionic, cationic, nonionic amphoteric surfactants; high molecular weight materials, such as synthetic or natural polymers, etc.; biomaterials; inorganic salts; etc., to form mesa phases, clusters, emulsions, microsphere or aggregated particles.

The said gel or solution for the synthesis of the zeolite comprising the organosilanes is further processed to produce a zeolite as described in the art. The synthesis is preferably performed in an autoclave at temperatures from 80 up to 200° C. After crystallization, the zeolite product is recovered by filtration or centrifugation. The crystallization process can be carried out by hydrothermal synthesis, dry-gel synthesis or microwave synthesis. After drying at typically 60° C., the product is calcined in air or oxygen gas at temperatures ranging from 400 to 700° C. to remove the organic groups and, if present, the separately added molecular organic template.

The zeolite product is conveniently characterized by X-Ray Diffraction (XRD). XRD pattern can be verified in appropriate databases. [Ref. 7] Other characterization methods employed are FT-IR and N₂ physisorption. The micropore volume can be determined from the N2 physisorption isotherm at 77K and interpretation of the adsorption isotherm using t-plot or or αₛ plot [Ref. 25]. A particular feature of the zeolite in the present invention is the enhanced pore volume that can be controlled by the fraction of organosilanes introduced in the synthesis mixture.

In a second object the present invention provides zeolites having an enhanced microporosity, such zeolites being obtained through the use of the method of the present invention. More particularly the use of organosilanes according to the method as described above allowed to prepare MFI type zeolites with a surprisingly high microporous volume. Therefore, the present invention relates to MFI-type zeolites obtainable by the present invention having a micropore volume of 0.18 ml/g or more, more preferably 20 ml/g or more, most preferably 22 ml/g or more, for instance 24 ml/g or more but wherein the micropore volume does not exceed 0.3 ml/g. In a particular embodiment the MFI type zeolite is an Al containing zeolite having a micropore volume of 0.18 ml/g or more, more preferably 20 ml/g or more, most preferably 22 ml/g or more, for instance 24 ml/g or more but wherein the micropore volume does not exceed 0.3 ml/g and wherein the Si/Al ratio varies between 1 and 60, more preferably between 20 and 60, for instance between 40 and 60. In another particular embodiment the MFI-type zeolite is an Ti containing zeolite having a micropore volume of 0.19 ml/g or more, more preferably 20 ml/g or more, most preferably 22 ml/g or more, for instance 24 ml/g or more but wherein the micropore volume does not exceed 0.3 ml/g and wherein the Ti/Al ratio varies between 1 and 60, more preferably between 20 and 60, for instance between 40 and 60. Furthermore, the method of present invention allows to obtain following zeolite materials:
zeolite having a zeolite framework of the type FER having a micropore volume between 0.16 and 0.26 ml/g, more preferably between 0.18 and 0.26 ml/g;
zeolite having a zeolite framework of the type TON having a micropore volume between 0.13 and 0.20 ml/g, more preferably between 0.15 and 0.20 ml/g;
zeolite having a zeolite framework of the type MTT having a micropore volume between 0.15 and 0.22 ml/g, more preferably between 0.17 and 0.22 ml/g;
zeolite having a zeolite framework of the type MEL having a micropore volume between 024 and 0.40 ml/g, more preferably between 0.28 and 0.40 ml/g;
zeolite having a zeolite framework of the type BEA having a micropore volume between 0.24 and 0.40 ml/g, more preferably between 0.28 and 0.40 ml/g.

The applicants are not aware of any previous disclosure describing MFT type zeolites with a microporous volume similar or higher than MFI type zeolites of the present inventions. Therefore, in a third object the present invention provides MFI-type zeolites having a micropore volume of 0.18 ml/g or more, more preferably 20 ml/g or more, most preferably 22 ml/g or more, for instance 24 ml/g or more but wherein the micropore volume does not exceed 0.3 ml/g. In a particular embodiment the MFI-type zeolite is an Al containing zeolite having a micropore volume of 0.18 ml/g or more, more preferably 20 ml/g or more, most preferably 22 ml/g or more, for instance 24 ml/g or more but wherein the micropore volume does not exceed 0.3 ml/g and wherein the Si/Al ratio varies between 1 and 60, more preferably between 20 and 60, for instance between 40 and 60. In another particular embodiment the MFI type zeolite is an Ti containing zeolite having a micropore volume of 0.19 ml/g or more, more preferably 20 ml/g or more, most preferably 22 ml/g or more, for instance 24 ml/g or more but wherein the micropore volume does not exceed 0.3 ml/g and wherein the Ti/Al ratio varies between 1 and 60, more preferably between 20 and 60, for instance between 40 and 60.

### EXAMPLES

### Example 1

### Synthesis of MFI Type Zeolites Using 20 mol. % of phenyl-trimethoxysilane

An amount of 14.6 g TEOS (tetraethoxy orthosilicate) was mixed with 3.5 g of phenyl-trimethoxysilane (PTMSi) in a propylene bottle at room temperature to obtain a 20 mol % mixture of TEOS and PTMSi. 16.0 g of TPAOH (tetrapropyl ammonium hydroxide, 40 wt. % aqueous solution) was added to this mixture under vigorous stirring. 10 Minutes after homogenization of the resulting mixture, 15.7 g of water was added and the stirring continued for another 24 h. The resulting “clear solution” was transferred to a 100 ml stainless steel autoclave and heated in an air oven at 120° C. for 3 days without stirring. The autoclave was cooled to room temperature using cold water and the reaction mixture was transferred in a propylene bottle. The reaction mixture was centrifuged at 12.000 rpm for 30 min. Then the crystals were separated from the mother liquor and dispersed in de-ionized water. The centrifugation/washing step was repeated 3 times. Finally, the zeolite crystals were transferred in porcelain plates and dried at 60° C. in an air oven for 12 h. The calcination step was carried out in an air oven at 550° C. for 5 h using a heating rate of 1° C./min.

### Example 2

### Synthesis of MFI Type Zeolites Using 5 mol. % of phenyl-trimethoxysilane

17.4 g of TEOS (tetraethoxy orthosilicate) was mixed with 0.87 g of phenyl-trimethoxysilane (PTMSi) in a propylene bottle at room temperature to obtain a 5 mol % mixture of TEOS and PTMSi. 16.0 g of TPAOH (tetrapropyl ammonium hydroxide, 40 wt. % aqueous solution) was added to this mixture under vigorous stirring. 10 Minutes after homogenization of the resulting mixture, 15.7 g of water was added and the stirring continued for another 24 h. The resulting “clear solution” was transferred to a 100 ml stainless steel autoclave and heated in an air oven at 120° C. for 3 days without stirring. The autoclave was cooled at room temperature using cold water and the reaction mixture was transferred to a propylene bottle. The reaction mixture was centrifuged at 12,000 rpm for 30 min. Afterwards the crystals were separated from the mother liquor and redispersed in de-ionized water. The centrifugation/washing step was repeated 3 more times. Finally, the zeolite crystals were transferred in porcelain plates and dried at 60° C. in an air oven for 12 h. The calcination step was carried out in an air oven at 550° C. for 5 h using a heating rate of 1° C./min.

### Example 3

### Synthesis of MEI Type Zeolites Using 5 mol. % of chloropropyl-trimethoxysilane

17.4 g of TEOS (tetroethoxyorthosilicate) was mixed with 0.87 g chloropropyl-trimethoxysilane (CIPTMSi) in a propylene bottle at room temperature to obtain a 5 mol % mixture of TEOS and CIPTMSi. 16.0 g of TPAOH (tetrapropyl ammonium hydroxide, 40 wt. % aqueous solution) was added to this mixture under vigorous stirring. 10 Minutes after homogenization of the resulting mixture, 15.7 g of water was added and the stirring continued for another 24 h. The resulting “clear solution” was transferred to a 100 ml stainless steel autoclave and heated in an air oven at 120° C. for 3 days without stirring. The autoclave was cooled at room temperature using cold water and the reaction mixture was transferred to a propylene bottle. The reaction mixture was centrifuged at 12,000 rpm for 30 min. Afterwards the crystals were separated from the mother liquor and redispersed in de-ionized water. The centrifugation/washing step was repeated 3 more times. Finally, the zeolite crystals were transferred in porcelain plates and dried at 60° C. in an air oven for 12 h. The calcination step was carried out in an air oven at 550° C. for 5 h using a heating rate of 1° C./min.

### Example 4

### Synthesis of MFI Type Zeolites Using 5 mol. % of aminopropyl-trimethoxysitane

17.4 g of TEOS (tetroethoxyorthosilicate) was mixed with 0.79 g aminopropyl-trimethoxyaane (APTMSi) in a propylene bottle at room temperature to obtain a 5 mol % mixture of TEOS and APTMSi. 16.0 g of TPAOH (tetrapropyl ammonium hydroxide, 40 wt. % aqueous solution) was added to this mixture under vigorous stirring. 10 Minutes after homogenization of the resulting mixture, 15.7 g of water was added and the stirring continued for another 24 h. The resulting “clear solution” was transferred to a 100 ml stainless steel autoclave and heated in an air oven at 120° C. for 3 days without stirring. The autoclave was cooled at room temperature using cold water and the reaction mixture was transferred to a propylene bottle. The reaction mixture was centrifuged at 12,000 rpm for 30 min. Afterwards the crystals were separated from the mother liquor and redispersed in de-ionized water. The centrifugation/washing step was repeated 3 more times. Finally, the zeolite crystals were transferred in porcelain plates and dried at 60° C. in an air oven for 12 h. The calcination step was carried out in an air oven at 550° C. for 5 h using a heating rate of 1° C./min.

### Example 5

### Comparative Example: Synthesis of MFI Type Zeolites Using 5 mol. % of hexadecyl-trimethoxysilane

An amount of 17.4 g TEOS (tetroethoxy orthosilicate) was mixed with 1.52 g hexadecyl-trimethoxysilane (HTMSi) in a propylene bottle at room temperature to obtain a 5 mol % mixture of TEOS and HTMSi. 16.0 g of TPAOH (tetrapropyl ammonium hydroxide, 40 wt. % aqueous solution) was added to this mixture under vigorous stirring. Finally, 15.7 g water was added and the stirring continued for another 24 h. The resulting mixture was transferred into a 100 ml stainless steel autoclave and heated in an air oven at 100° C. for 3 days without stirring. The autoclave was cooled at room temperature using cold water and the reaction mixture was transferred in a propylene bottle. The reaction mixture was centrifuged at 12,000 rpm for 30 min, and then the precipitate was separated from the mother liquor and redispersed in de-ionized water. The centrifugation/washing step was repeated 3 times. Finally, the precipitate was transferred in porcelain plates and dried at 60° C. in an air oven for 12 h. The calcination step was carried out in an air oven at 550° C. for 5 h using a heating rate of 1° C./min.

This example making use of a silane compound outside the embodiment of the present invention having a Si—R moiety with more than 10 C atoms. Two separate phases were obtained, one phase consisting of MFI crystals, the second phase of an amorphous material.

### Example 6

### Comparative Example: Synthesis of MFI Type Silicalite Zeolite with 10 mol % of hexadecyl-trimethoxysilane in Fluoride Medium

An amount of 4.26 g of tetrapropylammonium bromide and 0.30 g of ammonium fluoride were dissolved at room temperature under stirring in 72 g of water. The resulting solution was added on 10.8 g silica (Aerosil 300) and the mixture was homogenized with a blender. Finally, 6.92 g hexadecyltdmetoxysilane was added to the mixture dropwise under stirring. The resulting mixture was transferred into a 100 ml stainless steel autoclave and heated at 200° C. for 14 days in an air oven without stirring. The precipitate was filtered and washed with de-ionized water and then dried at 60° C. in an air oven for 12 h. The calcination step was carried out in an air oven at 550° C. for 5 h using a heating rate of 1° C./min.

### Example 7

### Comparative Example: Synthesis of MFI Type Silicalite Zeolite According to [Ref. 23]

An amount of 18.3 g of TEOS (tetroethoxy orthosilicate) was added to 16.0 g of TPAOH (tetrapropyl ammonium hydroxide, 40 wt. % aqueous solution) under vigorous stirring at room temperature in a propylene bottle. 10 Minutes after homogenization of the resulting mixture homogenized, 15.7 g water was added and the stirring continued for another 24 h. The resulting “clear solution” was transferred to a 100 ml stainless steel autoclave and heated in an air oven at 120° C. for 3 days without stirring. The autoclave was cooled at room temperature using cold water and the reaction mixture was transferred to a propylene bottle. The reaction mixture was centrifuged at 12.000 rpm for 30 min. Then the crystals were separated from the mother liquor and redispersed in de-ionized water. The centrifugation/washing step was repeated 3 times. Finally, the zeolite crystals were transferred in porcelain plates and dried at 60° C. in an air oven for 12 h. The calcination step was carried out in an air oven at 550° C. for 5 h using a heating rate of 1° C./min.

### Example 8

### Synthesis of MFI Type Zeolites Containing Al (Si/Al=50) with 20 mol % of phenyl-trimethoxysilane

An amount of 14.6 g of TEOS (tetroethoxy orthosilicate) was mixed with 3.5 g of phenyl-trimethoxysilane (PTMSi) in a propylene bottle at room temperature to obtain a 20 mol % mixture of TEOS and PTMSi. 0.047 g of Al powder was dissolved in 16.0 g of TPAOH (tetrapropyl ammonium hydroxide, 40 wt. % aqueous solution) under vigorous stirring at room temperature for 24 h. The resulting solution was added to the TEOS-PTMSi mixture under vigorous stirring. 10 Minutes after the homogenization of the mixture, 15.7 g of water was added and the stirring continued for another 24 h. The resulting “clear solution” had a Si/Al molar ratio of 50. The resulting “clear solution” was transferred to a 100 ml stainless steel autoclave and heated in an air oven at 120° C. for 3 days without stirring. The autoclave was cooled to room temperature using cold water and the reaction mixture was transferred in a propylene bottle. The reaction mixture was centrifuged at 12.000 rpm for 30 min, and then the crystals were separated from the mother liquor and redispersed in de-ionized water. The centrifugation/washing step was repeated 3 times. Finally, the zeolite crystals were transferred in porcelain plates and dried at 60° C. in an air oven for 12 h. The calcination step was carried out in an air oven at 550° C. for 5 h using a heating rate of 1° C./min.

### Example 9

### Comparative Example: Synthesis of MEI Type Zeolites Containing Al (Si/Al=50) after [Ref. 24]

An amount of 0.0475 g of Al powder was dissolved in 16.0 g of TPAOH (tetrapropyl ammonium hydroxide, 40 wt. % aqueous solution) in a propylene bottle under vigorous stirring at room temperature for 24 h. 18.3 g of TEOS was added to the resulting tetrapropyl ammonium aluminate solution under vigorous stirring. 10 minutes after homogenization of the resulting mixture, 15.7 g of water was added and the stirring continued for another 24 h. The resulting “clear solution” was transferred to a 100 ml stainless steel autoclave and heated in an air oven at 120° C. for 3 days without stirring. The autoclave was cooled at room temperature using cold water and the reaction mixture was transferred to a propylene bottle. The reaction mixture was centrifuged at 12.000 rpm for 30 min. Then the crystals were separated from the mother liquor and redispersed in de-ionized water. The centrifugation/washing step was repeated 3 times. Finally, the zeolite crystals were transferred in porcelain plates and dried at 60° C. in an air oven for 12 h. The calcination step was carried out in an air oven at 550° C. for 5 h using a heating rate of 1° C./min.

### Example 10

### Synthesis of MFI Type Zeolites Containing Ti (Si/Ti=40) and 10 mol % of phenyl-triethoxysilane

An amount of 16.1 g TEOS (tetroethoxy orthosilicate) was mixed with 2.1 g of phenyl-triethoxysilane (PTESi) in a propylene bottle at room temperature to obtain a 10 mol % mixture of TEOS and PTESi. Afterwards, 0.67 g of TBOT (tetrabutyl orthotitnate) was added dropwise and the mixture was stirred for another 30 minutes. This mixture was added under vigorous stirring to 15.7 g TPAOH (tetrapropyl ammonium hydroxide, 40 wt. % aqueous solution) at room temperature. After 30 minutes stirring the mixture becomes clear and 15.3 g of water was added and stirred overnight. The final “clear solution” had a Si/Ti molar ratio of 40. The mixture was transferred in a 100 ml stainless steel autoclave and heated in an air oven at 120° C. for 2 days without stirring. The autoclave was cooled at room temperature using cold water and the reaction mixture was transferred to a propylene bottle. The reaction mixture was centrifuged at 12.000 rpm for 30 min. Then the crystals were separated from the mother liquor and redispersed in de-ionized water. The centrifugation/washing step was repeated 3 times. Finally, the zeolite crystals were transferred in porcelain plates and dried at 60° C. in an air oven for 12 h. The calcination step was carried out in an air oven at 550° C. for 5 h using a heating rate of 1° C./min.

### Example 11

### Comparative Example: Synthesis of MA Type Zeolites Containing Ti (Si/Ti=40)

An amount of 18 g of TEOS (tetroethoxy orthosilicate) was mixed 0.75 g of TBOT (tetrabutyl orthotitanate) in a 100 ml propylene bottle. This mixture was added under vigorous stirring to 15.8 g of TPAOH (tetrapropyl ammonium hydroxide, 40 wt. % aqueous solution) at room temperature. After 30 minutes stirring the Mixture becomes clear and 15.4 g of water was added and stirred overnight. The final “clear solution” had a Si/Ti molar ratio of 40. The mixture was transferred in a 100 ml stainless steel autoclave and heated in an air oven at 120° C. for 2 days without stirring. The autoclave was cooled at room temperature using cold water and the reaction mixture was transferred in a propylene bottle. The reaction mixture was centrifuged at 12.000 rpm for 30 min. Then the crystals were separated from the mother liquor and redispersed in de-ionized water. The centrifugation/washing step was repeated 3 times. Finally, the zeolite crystals were transferred in porcelain plates and dried at 60° C. in an air oven for 12 h. The calcination step was carried out in an air oven at 550° C. for 5 h using a heating rate of 1° C./min.

### Example 12

### Physico-Chemical Characterization of Zeolites Prepared According to the Invention and Comparative Samples Outside the Invention

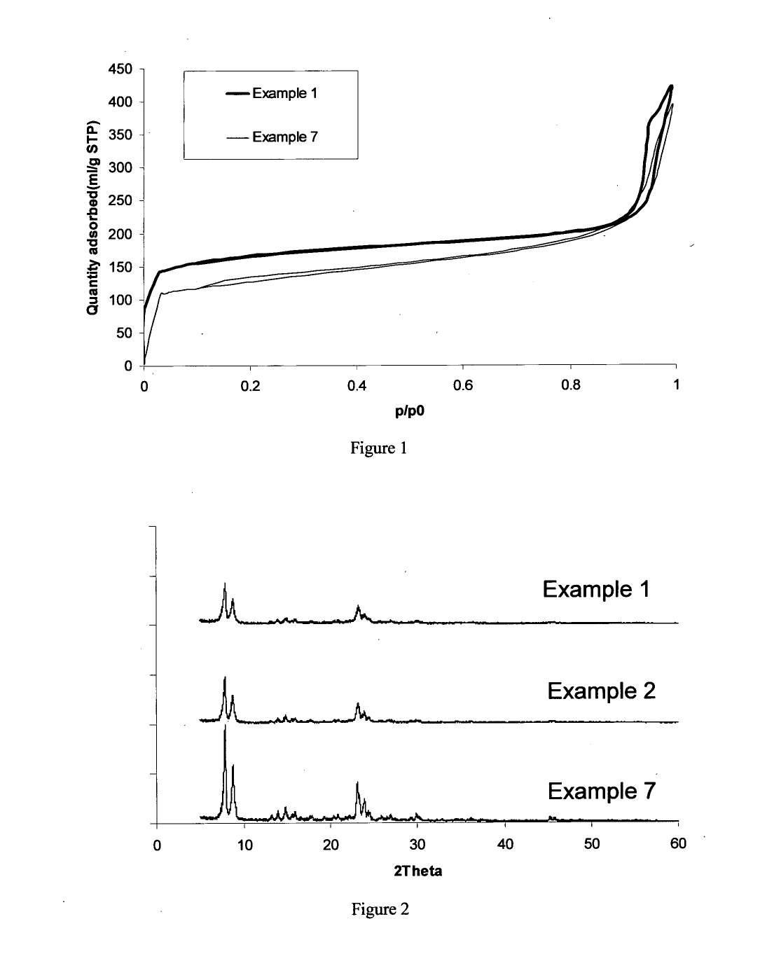

The zeolite materials prepared in the EXAMPLES were characterized using three different techniques: nitrogen adsorption, X-ray diffraction (XRD) and Fourier Transform Infrared spectroscopy (FT-IR). FIG. 1 presents the nitrogen physisorption isotherms at −196° C. on the calcined zeolite materials from EXAMPLE 1 and EXAMPLE 7. In the zeolite material made according to the invention (EXAMPLE 1) over the relative pressure range, P/P°, there is a higher nitrogen uptake than in the reference zeolite sample prepared in EXAMPLE 7. The larger nitrogen uptake represents a larger zeolite pore volume. The differences in the adsorption isotherms reveal that the addition of organosilane molecules to the synthesis mixture leads to the formation of zeolite product with an enhanced pore volume after the removal of the organic moieties by calcination. A list of results from the characterization with nitrogen adsorption of MFI type zeolite materials obtained from the EXAMPLES is given in Table 1.

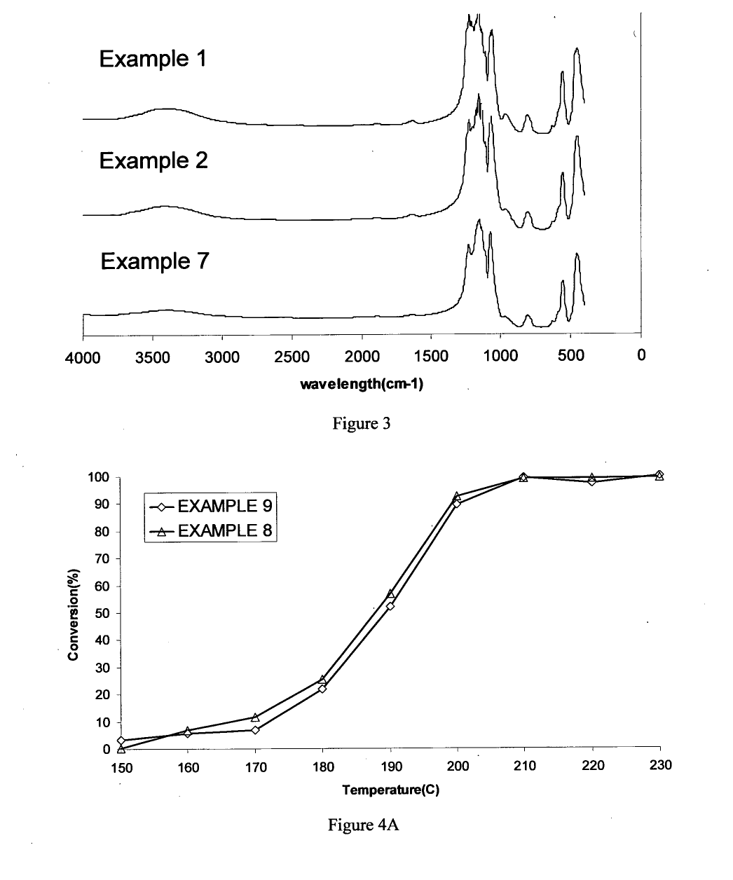

The reference zeolites prepared using published synthesis recipes in EXAMPLE 7 and EXAMPLE 9 have a micropore volume of 0.15 and 0.12 ml/g, respectively. The zeolites prepared according to the invention have a larger micropore volume in the ranging from 0.18 to 0.26 ml/g depending on the specific EXAMPLE. The Ti-containing zeolite prepared according to the invention, also showed an enhanced pore volume compared to the reference material. The same is true for the Al-containing mordenite-type zeolite. The crystallinity of the zeolite samples prepared according to the invention was verified using XRD. The XRD patterns of the zeolites prepared in EXAMPLE 1, EXAMPLE 2 and of the reference zeolite prepared in EXAMPLE 7 are shown in FIG. 2. The XRD pattern for the zeolite materials of EXAMPLE 1 and 2 prepared according to the invention shows the characteristic diffraction lines of the MFI structure present in the reference sample prepared in EXAMPLE 7. The FT-IR spectra of the same three samples are presented in FIG. 3. MFI type zeolites present characteristic absorption bands at 450 and 550 cm⁻¹. These bands are present in the zeolites from EXAMPLES 1 and 2 and in the reference zeolite from EXAMPLE 7.

Table 2 further provides the mesopore volume of the respective samples. This mesopore volume varies between 0.02 and 0.1 ml/g in between samples. FIG. 5 represents the mesopore size distribution (range of pore diameters 2-50 nm) of the zeolites synthesized in Example 1 and example 7 (comparative example). There are two maxima in the distribution: 2 nm: this is the tail of the contribution of the micropores; and above 20 nm: these are pores created by roughness of the crystals and interstitial voids between crystallites.

### Example 13

### Catalytic Activity: n-decane Hydroisomerization

The zeolite materials obtained in EXAMPLE 8 according to the invention and in EXAMPLE 9 following a reference procedure from literature were evaluated for catalytic activity in the n-decane hydroisomerization reaction. The materials were tested in a high through-put reactor described in detail in literature. [Ref. 26] Before the catalytic test, the ammonium exchanged zeolite materials were impregnated with 0.5 wt % Pt using an aqueous solution of [Pt(NH₃)₄]Cl₂.H₂O and then dried at 60° C. for 12 h. An amount of 50 mg of impregnated catalyst was placed in the reactor and, pretreated at 400° C. for 1 h in O₂, 30 min in N₂ and finally 1 h in H₂. Samples were then cooled at the reaction temperature and the system was stabilized for 1 h in H₂ flow. The reaction conditions were: temperature interval from 150 to 300° C. with a 10° C./step, a molar ratio H₂ to n-decane of 375, a fixed contact time of 1656 kg s/mot. Reaction product samples were collected at each reaction temperature and analyzed via on-line gas chromatography.

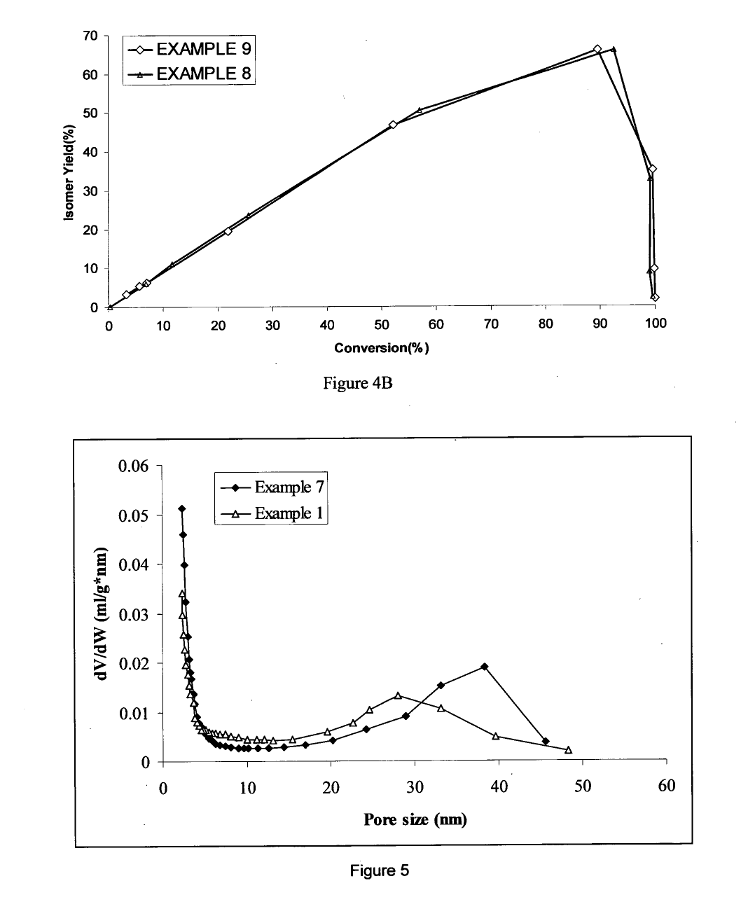

The conversion of decane obtained at increasing reaction temperature is presented in FIG. 4A. The conversions obtained on the zeolite according to the invention (EXAMPLE 8) are similar to that of the unmodified material (EXAMPLE 9). The yield of decane skeletal isomers is plotted versus conversion in FIG. 4B. The yield of skeletal isomers on the two zeolites is very similar. When the skeletal isomerization products are analyzed for their branching degree, a marked difference was found. At the maximum yield of isomerization, the C10 isomer product fraction obtained according to the invention contained 25% of dibranched isomers, whereas with the reference zeolite prepared according to EXAMPLE 9 the content of dibranched isomers was 17% only.

### Example 14

### Liquid Phase Epoxidation of Hexene and Cyclohexene with Hydrogen Peroxide on Ti Containing Zeolites

Titanosilicate zeolite sample from EXAMPLE 10 made according to the invention and a reference sample prepared according to literature in EXAMPLE 11 were tested for their catalytic activity in the liquid phase epoxidation of cyclohexene with hydrogen peroxide. The reaction procedure was as follows: 0.45 ml cyclohexene was mixed with 5 ml methanol in a 10 ml glass reactor, followed by the addition of 0.19 ml of 35 wt. % H₂O₂ in water. To this solution 0.03 g of catalyst was added. Afterwards the reactor was sealed and placed in a heated copper block equipped with a magnetic stirring device. The reaction mixtures were heated at 40° C. for 24 h. The reaction was stopped after 24 h by separating the catalyst from the reaction mixture using centrifugation at 10,000 rpm. The mixture was analyzed using GC and the products identified using reference samples and GC-MS.

The results are presented in Table 2. The material from EXAMPLE 10 presented the same level of activity as the reference material (EXAMPLE 11) for the cyclohexene substrate. The epoxide selectivity was 31% on the zeolite according to the invention, and only 15% when using the reference zeolite.

### Example 15

### Synthesis of BEA Type Zeolite Using 5 mot % of phenyl-trimethoxysilane

23.3 g tetraethyl-ammoniumhydroxide (TEAOH) (20 wt. % aqueous solution) were mixed with 5 g of freeze dried colloidal silica Ludox SM 30 (30 wt. %) under vigorous stirring. Subsequently, an amount of 0.87 g phenyl-trimetoxysilane (PTMSi) was added. The mixture was aged for 24 h at room temperature. The resulting mixture was transferred to a stainless steel autoclave and heated in an air oven at 100° C. for 10 days. The autoclave was cooled at room temperature using cold water and the reaction mixture was transferred in a propylene bottle. The reaction mixture was centrifuged at 12.000 rpm for 30 min. Then the crystals were separated from the mother liquor and dispersed in de-ionized water. The centrifugation/washing step was repeated 3 times. Finally, the zeolite crystals were transferred in porcelain plates and dried at 60° C. in an air oven for 12 h. The calcination step was carried out in an air oven at 550° C. for 5 h using a heating rate of 1° C./min.

### REFERENCES CITED

[1] “Atlas of Zeolite Framework Type” 5^{th} edition; Elsevier (2001); Ed. Baerlocher, Ch.; Meier, W. M.; Olson, D. H; p. 3.
[2] Meier, W. M.; PureAppl. Chem., 58(10) (1986) 1323.
[3] Tielen, M.; Geelen, M.; Jacobs, P. A.; Acta Physica et Chemica 31(1-2) (1985) 1.
[4] Agauer, R. J.; Landolt, G R.; U.S. Pat. No. 3,702,886.
[5] Flanigen, E. M.; Bennett, J. M.; Grose, R. W.; Cohen, J. P.; Patton, R. L.; Kirchner, R. M.; Smith, J. V.; Nature 271 (1978) 512.
[6] Cundy, C. S.; Cox, P. A.; Chem. Rev. 103(3) (2003) 663.
[7] “Atlas of Zeolite Framework Types” 5^{th} edition; Elsevier (2001); Ed. Baerlocher, Ch.; Meier, W. M.; Olson, D. H.
[8] Martens, J. A.; Jacobs, J. A.; Adv. Funct. Mater. 11(5) (2001) 337.
[9] Tosheva, L.; Vaitchev, V. P.; Chem. Mater. 17(10) (2005) 2494.
[10] Tao, Y.; Kanoh, H.; Abrams, L.; Kaneko, K.; Chem. Rev. 106(3) (2006) 896.
[11] Kremer, S. P. B.; Kirschhock, C. E. A.; Aerts, A.; Villani, K.; Martens, J. A.; Lebedev, O. I.; Van Tendeloo, G.; Adv. Mater. 20 (2003) 1705.
[12] Aerts, A; van Isacker, A.; Huybrechts, W.; Kremer, S. P. B.; Kirschhock, C. E. A.; Collignon, F.; Houthoofd, K.; Denayer, J. F. M.; Baron, G. V.; Marin, G. B.; Jacobs, P. A.; Martens, J. A.; Appl. Catal. A: Gen. 257 (2004) 7.
[13] Liu, Y.; Zhang, W.; Pinnavaia, T. J.; J. Am. Chem. Soc. 122 (2000) 8791.
[14] Liu, Y.; Zhang, W.; Pinnavaia, T. J.; Angew. Chemint. Ed. 40 (2001) 1255.
[15] Zhang, Z.; Han, Y.; Zhu, L.; Wang, R.; Yu, Y.; Qiu, S.; Zhao, D.; Xiao, F.-S.; Angew. Chem. Int. Ed. 40 (2001) 1258.
[16] D. T. On; S. Kaliaguine, Angew. Chem. Int. Ed. 40 (2001) 3248.
[17] Huang, L; Wang, Z.; Sun, J.; Miao, L.; Li, Q.; Van, Y.; Zhao, D.; J. Am. Chem. Soc. 122 (2000) 3530.
[18] Holland, B. T.; Abrams, L.; Stein, A.; J. Am. Chem. Soc. 121(17) (1999) 4308.
[19] Choi, M.; Cho, H. S.; Srivastava, R.; Venkatesan, C.; Choi, D.-H.; Ryoo, R.; Nature Materials 5 (2006) 718.
[20] “Verified Syntheses of Zeolitic Materials” 2^{nd} Edition; Elsevier (2001); Ed. Baerlocher, Ch.; Meier, W. M.; Olson, D. H.
[21] Kuhl, G.; in “Verified Syntheses of Zeolitic Materials” 2^{nd} edition; Elsevier (2001); Ed. Ch. Baerlocher, Ch.; Meier, W. M.; Olson, D. H.; p. 19.
[22] Caullet, P.; Paillaud, J.-L.; Simon-Masseron, A.; Soulard, M.; Patarin, J.; Comptes Rendus Chimie 8 (3-4) (2005) 245.
[23] Persson, A. E.; Schoeman, B. J.; Sterte, J.; Otterstedt, J.-E.; Zeolites 14(7) (1994) 557.
[24] A. Aerts, W. Huybrechts, S. P. B. Kremer, C. E. A. Kirschhock, E. Theunissen, A. van Isacker, J. F. M. Denayer, G. V. Baron, J. Thybaut, G. B. Marin, P. A. Jacobs and J. A. Martens, Chem. Comm. 15 (2003) 1888.
[25] a) Lippens, B. C.; de Boer, J. H.; J. Catal. 4 (1965) 319. b) Sing, K. S. W.; Chem.& Ind. 829.
[26] Huybrechts, W.; Mijoin, J.; Jacobs, P. A.; Martens, J. A.; Appl. Catal. A: Gen. 243 (2003) 1.

### TABLES

TABLE 1
Micropore and mesopore volume of MFI type
zeolites according to N2 physisorption

| | Micropore Volume | Mesopore Volume |
|---|---|---|
| Material | (ml/g)^{a} | (2-10 nm) (ml/g)^{b} |
| Example 1 | 0.24 | 0.05 |
| Example 2 | 0.22 | 0.07 |
| Example 3 | 0.26 | 0.06 |
| Example 4 | 0.22 | 0.06 |
| Example 6° | 0.17 | 0.02 |
| Example 7° | 0.15 | 0.05 |
| Example 8 | 0.18 | 0.1 |
| Example 9° | 0.12 | 0.09 |
| Example 10 | 0.22 | 0.07 |
| Example 11° | 0.18 | 0.06 |

^{a}determined using t-plot method. [Ref. 25]
^{b}determined using BJH cumulative pore volume.
°comparative example

TABLE 2
Alkene epoxidation on Ti containing materials.

| Catalyst | Sunstrate | Conversion (%) | Selectivity epox. (%) |
|---|---|---|---|
| Example 10 | Cyclohexene | 4 | 31 |
| Example 11 | Cyclohexene | 4 | 15 |

1-18. (canceled)

19. A method for the synthesis of a zeolite, said method comprising the steps of:
(a) the preparation of a gel or solution for the synthesis of a zeolite, said gel or solution comprising (i) a silica source, (ii) a molecular template, (iii) an organosilane and (iv) a source of titanium, aluminum, boron, gallium, germanium, iron or phosphorous;
(b) a crystallization process;
(c) recovery of the obtained zeolite material;
(d) drying of the obtained zeolite material; and
(e) calcinations thereof to remove all organic moieties and molecular template;
wherein said organosilane is
a compound according to the general formula Si(OR₁)ₓ(R₂)_{y}(R₃)_{z}(R₄)_{w} in which x can be 1, 2 or 3; each y, z and w can be 0, 1, 2, or 3 and x+y+z+w=4 and in which R₁ is an alkyl group selected from methyl, ethyl, propyl or a longer aliphatic chain, and wherein
each R₂, R₃ and R₄ are independently selected from a C₁₋₃ alkyl, C₁₋₃ alkenyl or an aromatic group wherein said alkyl, alkenyl or aromatic group may have at least one substituent selected from the group consisting of amino, nitro, cyano, amide ammonium, alcohol, halide, alkene, phenyl, thiol carboxylic acid, sulphonic acid, haloalkyl, glycidyl, aryl and heteroaryl;
but none of R₂, R₃ and R₄ comprises a quaternary ammonium.

20. The method according to claim 19 wherein R₂, R₃ and R₄ represent a methyl wherein said methyl may have at least one substituent selected from the group consisting of amino, nitro, cyano, amide ammonium, alcohol, halide, alkene, phenyl, thiol carboxylic acid, sulphonic acid, glycidyl, aryl and heteroaryl;
R₂, R₃ and R₄ may be the same or different but none of R₂, R₃ and R₄ comprises a quaternary ammonium.

21. The method according to claim 19 wherein R₂, R₃ and R₄ represent an aromatic group wherein said aromatic group may have at least one substituent selected from the group consisting of amino, nitro, cyano, amide ammonium, alcohol, halide, alkene, phenyl, thiol carboxylic acid, sulphonic acid, haloalkyl, glycidyl, aryl and heteroaryl;
R₂, R₃ and R₄ may be the same or different but none of R₂, R₃ and R₄ comprises a quaternary ammonium.

22. The method according to claim 21 wherein the aromatic group is a phenyl-group.

23. The method according to claim 21 wherein the said organosilane is selected from the group consisting of phenyl-trimethoxysilane, amino-phenyl-trimethoxysilane (o- and p-isomers), bromo-phenyl-trimethoxysilane, chloro-phenyl-trimethoxysilane, and p-chloromethyl-phenyl-trimethoxysilane.

24. The method according to claim 19 wherein the fraction of silicon atoms introduced as organosilanes into said synthesis gel or solution for the synthesis of a zeolite is in the range from 0.01 to 0.50.

25. The method according to claim 19 wherein said synthesis gel or solution for the synthesis of a zeolite comprises no or less than 1 mol % based on the amount of SiO₂ or its precursor of an additive capable of noncovalently bonding with each other and with the said organosilanes in order to form supramolecular structures larger than 2 nm incorporating the said organosilanes.

26. The method according to claim 25 wherein said synthesis gel or solution for the synthesis of a zeolite comprises no additives capable of noncovalently bonding with each other and with the said organosilanes in order to form supramolecular structures larger than 2 nm incorporating the said organosilanes.

27. The method according to claim 25 wherein said additives are selected from the group consisting of hydrocarbons, alcohols, surfactants, synthetic and natural polymers and combinations thereof.

28. The method according to claim 19 for the synthesis of a zeolite having a zeolite framework of the type BEA, FER, MEL, MFI, MTN, TON.

29. A zeolite with a zeolite framework of the type MFI having a micropore volume of 0.22 ml/g or more and a mesopore volume between 0.02 and 0.1 ml/g.

30. The MFI zeolite according to claim 29 obtained using the method according to claim 19.

31. The MFI zeolite according to claim 30 wherein said organosilane is selected from the group consisting of phenyl-trimethoxysilane, chloropropyl-trimethoxysilane and phenyl-triethoxysilane.

32. A zeolite with a zeolite framework of the MFI type having a micropore volume of at least 0.18 ml/g wherein said zeolite comprises Al in Si/Al ratio between 10 and 60.

33. A zeolite with a zeolite framework of the MFI type having a micropore volume of at least 0.19 ml/g wherein said zeolite comprises Ti in Si/Ti ratio between 10 and 60.
